(19) United States
(12) Patent Application Publication
(10) Pub. No.: US 2014/0297063 A1
(43) Pub. Date: Oct. 2, 2014

(54) VEHICLE SPECIFYING APPARATUS

(71) Applicant: Mitsuhisa Shida, Fuji-shi (JP)

(72) Inventor: Mitsuhisa Shida, Fuji-shi (JP)

(73) Assignee: TOYOTA JIDOSHA KABUSHIKI KAISHA, Toyota-shi (JP)

(21) Appl. No.: 14/358,871

(22) PCT Filed: Nov. 21, 2011
(86) PCT No.: PCT/JP2011/076809

§ 371 Date: May 16, 2014

(51) Int. Cl. G08G 1/16

(52) U.S. Cl. CPC G08G 1/163
USPC 701/1

(57) ABSTRACT

A vehicle specifying apparatus (100) is provided with: an obtaining device (1) configured to obtain, by communication, first behavior information associated with one or a plurality of communication vehicles which drive around a self-vehicle and which can communicate with the self-vehicle; and a detecting device configured to detect second behavior information associated with other vehicles which drive around the self-vehicle. The vehicle specifying apparatus is configured to compare the obtained first behavior information with the detected second behavior information, thereby specifying a preceding vehicle of the self-vehicle. The vehicle specifying apparatus is further provided with: a determining device configured to determine whether or not a particular vehicle, which is a vehicle specified as the preceding vehicle, is set as a preceding vehicle candidate, according to whether or not detection of the particular vehicle by the detecting device is stopped when the particular vehicle is detected by the detecting device.

### TECHNICAL FIELD

The present invention relates to, for example, a vehicle specifying apparatus configured to specify a preceding vehicle on the basis of behavior of other vehicles detected in mutually different systems.

### BACKGROUND ART

As this type of apparatus, for example, there is proposed an apparatus configured to compare a speed change detected by an autonomous sensor with a speed change obtained by vehicle-to-vehicle communication, thereby determining whether or not another vehicle as a detection target of the autonomous sensor is the same as another vehicle as a communication target of the vehicle-to-vehicle communication (refer to Patent document 1).

Alternatively, there is proposed an apparatus configured to calculate an integrated value of a finite difference between (i) a difference between a distance traveled by each of other vehicles based on position information about each of the other vehicles obtained by communication and a distance traveled by a self-vehicle, and (ii) the amount of change in inter-vehicle distance between the self-vehicle and a vehicle ahead detected by radar, thereby determining the other vehicles as communication destinations to be vehicle-ahead candidates under the condition that an absolute value of the calculated integrated value of the finite difference is less than an absolute value of a threshold value (refer to Patent document 2).

### PRIOR ART DOCUMENT

### Patent Document

Patent document 1: Japanese Patent Application Laid Open No. 2008-046873
Patent document 2: Japanese Patent Application Laid Open No. 2010-231358

### SUMMARY OF INVENTION

### Subject to be Solved by the Invention

In the aforementioned background art, the comparison and the determination are performed every time a new vehicle enters in a communication range of the self-vehicle, and for example, a processing load by an electronic control unit (ECU) of the self-vehicle likely increases, which is technically problematic.

In view of the aforementioned problems, it is therefore an object of the present invention to provide a vehicle specifying apparatus configured to reduce the processing load.

### Means for Solving the Subject

The above object of the present invention can be solved by a vehicle specifying apparatus is provided with an obtaining device configured to obtain, by communication, first behavior information associated with one or a plurality of communication vehicles which drive around a self-vehicle and which can communicate with the self-vehicle, and a detecting device configured to detect second behavior information associated with another vehicle that drives around the self-vehicle, said vehicle specifying apparatus configured to compare the obtained first behavior information with the detected second behavior information, thereby specifying a preceding vehicle of the self-vehicle, said vehicle specifying apparatus is further provided with a determining device configured to determine whether or not a particular vehicle, which is a vehicle specified as the preceding vehicle, is set as a preceding vehicle candidate, according to whether or not detection of the particular vehicle by the detecting device is stopped when the particular vehicle is detected by the detecting device.

According to the vehicle specifying apparatus of the present invention, the vehicle specifying apparatus is provided with the obtaining device, the detecting device, and the determining device. The obtaining device such as, for example, a communicator, obtains, by communication, the first behavior information associated with one or a plurality of communication vehicles which drive around the self-vehicle and which can communicate with the self-vehicle. The detecting device such as, for example, a radar, detects the second behavior information associated with another vehicle that drives around the self-vehicle.

Here, the “self-vehicle” means a vehicle in which the vehicle specifying apparatus is installed. The “communication vehicle” means a vehicle that can communicate with the self-vehicle, for example, by vehicle-to-vehicle communication or the like. The “another vehicle” includes the communication vehicle and a non-communication vehicle which is a vehicle that does not respond to the communication with the self-vehicle.

The vehicle specifying apparatus compares the first behavior information obtained by communication, with the detected second behavior information, thereby specifying the preceding vehicle of the self-vehicle. Specifically, for example, the vehicle specifying apparatus compares time variation of position or amount of movement based on position information about the communication vehicle(s) included in the first behavior information, with time variation of distance or amount of movement based on distance information between the self-vehicle and the another vehicle included in the second behavior information, thereby specifying the communication vehicle that allows the two types of time variation to match, as the preceding vehicle of the self-vehicle.

If the particular vehicle, which is the vehicle (i.e. the communication vehicle) specified as the preceding vehicle by the vehicle specifying apparatus, is continuously detected by the detecting device, then, the determining device which is provided with, for example, a memory, a processor, and the like determines whether or not the particular vehicle is set as the preceding vehicle candidate when the preceding vehicle is specified next time, according to whether or not the detection of the particular vehicle by the detecting device is stopped.

The case where the “detection of the particular vehicle by the detecting device is stopped” includes, for example, a case where a new vehicle cuts in between the self-vehicle and the particular vehicle, or a case where the particular vehicle changes lanes, or turns right or left, and the like.

Here, the study of the present inventor has revealed the following matter; namely, there has been proposed tracking control such as, for example, adaptive cruise control (ACC) in which an inter-vehicle distance between the self-vehicle and the preceding vehicle is detected by radar, and the self-vehicle is made track the preceding vehicle while keeping the inter-vehicle distance between the self-vehicle and the preceding vehicle substantially constant on the basis of speed or velocity of the self-vehicle and the detected inter-vehicle distance. Moreover, there has been proposed cooperative adaptive cruise control (CACC) in which the inter-vehicle distance between the self-vehicle and the preceding vehicle is set relatively short if the preceding vehicle is the vehicle that can communicate with the self-vehicle by the vehicle-to-vehicle communication (i.e. the communication vehicle), and which allows column driving.

There is a possibility that the plurality of communication vehicles exist in a communicable range of the vehicle-to-vehicle communication, and the communication vehicle that communicates with the self-vehicle is not necessarily the preceding vehicle of the self-vehicle (i.e. the vehicle directly detected by radar by the self-vehicle). Therefore, by specifying whether or not the preceding vehicle of the self-vehicle is the communication vehicle, it is possible to perform the tracking control preferable to the self-vehicle. On the other hand, if there are the plurality of communication vehicles in the communicable range of the vehicle-to-vehicle communication, and if, for example, the velocity or the like is similar between the plurality of communication vehicles, then, it likely becomes hard to specify the preceding vehicle, and the processing load likely increases.

In the present invention, however, as described above, if the particular vehicle specified as the preceding vehicle of the self-vehicle is continuously detected by the detecting device, then, it is determined by the determining device whether or not the particular vehicle is set as the preceding vehicle candidate, according to whether or not the detection of the particular vehicle by the detecting device is stopped.

Specifically, if the detection of the particular vehicle by the detecting device is stopped, the determining device excludes the particular vehicle from the preceding vehicle candidate. In other words, if the detection by the detecting device (i.e. direct detection) is stopped, the determining device excludes the particular vehicle from the preceding vehicle candidate because there is extremely little chance that the particular vehicle (i.e. the preceding vehicle until now) becomes the preceding vehicle again. By virtue of such a configuration, it is possible to reduce the number of the communication vehicles to compare even if there are the plurality of communication vehicles in the communicable range of the vehicle-to-vehicle communication, thereby reducing the processing load of the vehicle specifying apparatus.

In one aspect of the vehicle specifying apparatus of the present invention, the determining device excludes the particular vehicle from the preceding vehicle candidate under the condition that the detection of the particular vehicle by the detecting device is stopped.

According to this aspect, it is possible to reduce the processing load of the vehicle specifying apparatus, relatively easily.

In another aspect of the vehicle specifying apparatus of the present invention, the determining device further sets the particular vehicle detected by the detecting device as the preceding vehicle candidate if communication from the particular vehicle is stopped when the particular vehicle is detected by the detecting device.

According to this aspect, when the particular vehicle (i.e. the communication vehicle as the current preceding vehicle) is directly detected by the detecting device, and if the communication from the particular vehicle is stopped, then, the determining device sets the directly detected particular vehicle as the preceding vehicle candidate when the preceding vehicle is specified next time. In other words, if the direct detection of the particular vehicle by the detecting device is maintained, the preceding vehicle is not changed even if the communication from the particular vehicle is stopped, and the determining device thus sets the directly detected particular vehicle as the preceding vehicle.

By virtue of such a configuration, it is possible to appropriately specify the preceding vehicle if the communication from the particular vehicle is recovered, and it is extremely useful in practice.

The operation and other advantages of the present invention will become more apparent from the embodiment explained below.

### BRIEF DESCRIPTION OF DRAWINGS

FIG. 1 is a conceptual diagram illustrating one example of a driving state of a self-vehicle in an embodiment.

FIG. 2 is a block diagram illustrating a main part of a configuration of the self-vehicle in the embodiment.

FIG. 3 are conceptual diagrams illustrating another example of the driving state of the self-vehicle in the embodiment.

FIG. 4 are conceptual diagrams illustrating another example of the driving state of the self-vehicle in the embodiment.

FIG. 5 is a flowchart illustrating vehicle specification processing in the embodiment.

FIG. 6 is a conceptual diagram illustrating a concept of relative velocity in the embodiment.

### MODES FOR CARRYING OUT THE INVENTION

Hereinafter, an embodiment of the vehicle specifying apparatus of the present invention will be explained with reference to the drawings.

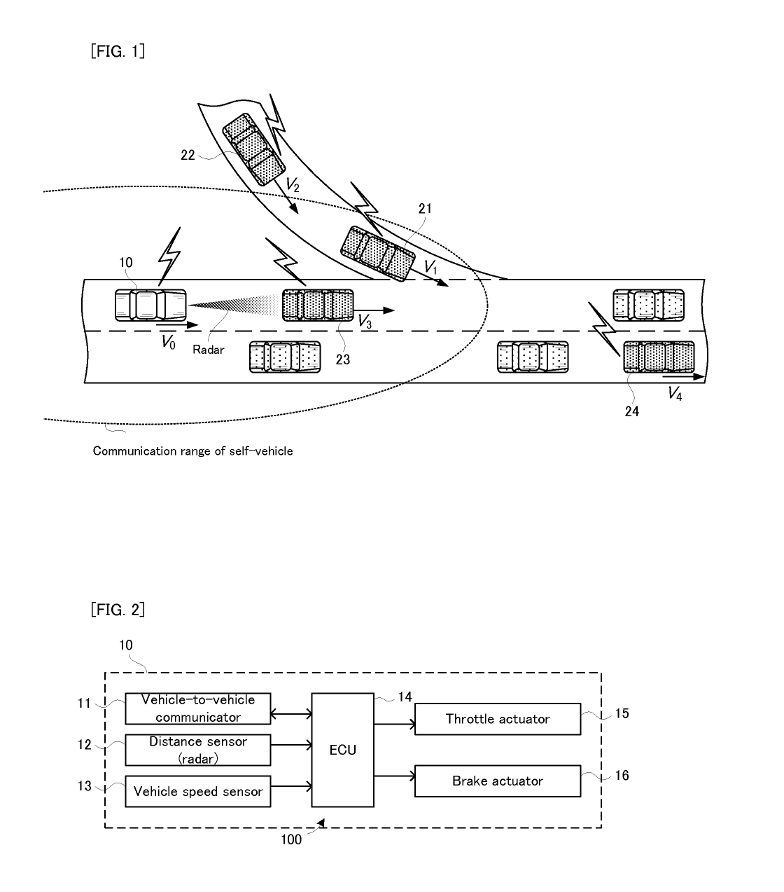

A self-vehicle 10 in the embodiment, for example, as illustrated in FIG. 1, is driving while receiving signals transmitted from communication vehicles (or vehicles 21 and 23 herein) which exist in a communicable range of the self-vehicle (or moreover, while transmitting information about the self-vehicle). The self-vehicle 10 further successively detects an inter-vehicle distance to the communication vehicle 23 by radar. The self-vehicle 10 performs the tracking control in which the communication vehicle 23 is set as a preceding vehicle, for example, on the basis of the speed of the self-vehicle 10, the detected inter-distance, the signal transmitted from the communication vehicle 23, and the like.

FIG. 1 is a conceptual diagram illustrating one example of a driving state of a self-vehicle in the embodiment. Incidentally, vehicles 21, 22, 23 and 24 in FIG. 1 are the communication vehicles (i.e. vehicles that can communicate with the self-vehicle 10). Vehicles without reference numerals are non-communication vehicles (i.e. vehicles that don't respond to the communication with the self-vehicle 10).

Next, a configuration of the self-vehicle 10 will be explained with reference to FIG. 2. FIG. 2 is a block diagram illustrating a main part of the configuration of the self-vehicle in the embodiment.

In FIG. 2, the self-vehicle 10 is provided with a vehicle-to-vehicle communicator 11, a distance sensor 12 provided with a radar or the like, a vehicle speed sensor 13, an ECU 14, a throttle actuator 15, and a brake actuator 16.

The ECU 14 obtains vehicle information such as, for example, a vehicle identifier (ID), speed or velocity, acceleration, position, and direction, associated with the communication vehicles which drive around the self-vehicle 10, via the vehicle-to-vehicle communicator 11. The distance sensor 12 detects the inter-vehicle distance to the preceding vehicle which drives ahead of the self-vehicle 10, and transmits a signal indicating the detected inter-vehicle distance to the ECU 14.

The ECU 14 controls the throttle actuator 15 or the brake actuator 16 to set a constant inter-vehicle distance between the self-vehicle 10 and the preceding vehicle, for example, according to an output signal from the distance sensor 12, an output signal from the vehicle speed sensor 13.

The vehicle specifying apparatus 100 in the embodiment is provided with the ECU 14 configured to compare the vehicle information obtained via the vehicle-to-vehicle communicator 11 with the inter-vehicle distance detected by the distance sensor 12, thereby specifying the preceding vehicle of the self-vehicle 10. More specifically, the ECU 14 compares, for example, a velocity profile of one communication vehicle based on the obtained vehicle information (e.g. time variation of velocity) with a velocity profile of the preceding vehicle based on the detected inter-vehicle distance, thereby specifying whether or not there is the communication vehicle corresponding to the preceding vehicle of the self-vehicle 10 among the communication vehicles which exist in the communicable range of the self-vehicle 10.

In the embodiment, the ECU 14 of the vehicle specifying apparatus 100 typically compares the vehicle information obtained via the vehicle-to-vehicle communicator 11 with the inter-vehicle distance detected by the distance sensor 12 when a new vehicle is detected by the distance sensor 12, thereby specifying the preceding vehicle of the self-vehicle 10. By virtue of such a configuration, it is possible to reduce the processing load of the ECU 14, for example, in comparison with the case where the preceding vehicle is specified every time a new communication vehicle enters in the communicable range of the self-vehicle 10, and it is extremely useful in practice.

In FIG. 1, the communication vehicle 23 is specified as the preceding vehicle of the self-vehicle 10 by the vehicle specifying apparatus 100. As a result, the ECU 14 controls the throttle actuator 15 or the brake actuator 16 to set the constant inter-vehicle distance between the self-vehicle 10 and the preceding vehicle, for example, according to the vehicle information associated with the communication vehicle 23 obtained via the vehicle-to-vehicle communicator 11, in addition to the output signal from the distance sensor 12 and the output signal from the vehicle speed sensor 13.

After one communication vehicle which exists in the communicable range of the self-vehicle 10 is specified as the preceding vehicle of the self-vehicle 10, when the one communication vehicle specified as the preceding vehicle (corresponding to the “particular vehicle” of the present invention) is detected by the distance sensor 12, the ECU 14 further determines whether or not the one communication vehicle specified as the preceding vehicle is a preceding vehicle candidate when the preceding vehicle of the self-vehicle 10 is specified next time, according to whether or not the detection of the one communication vehicle specified as the preceding vehicle by the distance sensor 12 is stopped.

Specifically, if the detection of the one communication vehicle specified as the preceding vehicle by the distance sensor 12 is stopped, the ECU 14 excludes the one communication vehicle specified as the preceding vehicle, from the preceding vehicle candidate when the preceding vehicle of the self-vehicle 10 is specified next time. On the other hand, if the detection of the one communication vehicle specified as the preceding vehicle by the distance sensor 12 is maintained, the ECU 14 includes the one communication vehicle specified as the preceding vehicle, in the preceding vehicle candidate when the preceding vehicle of the self-vehicle 10 is specified next time.

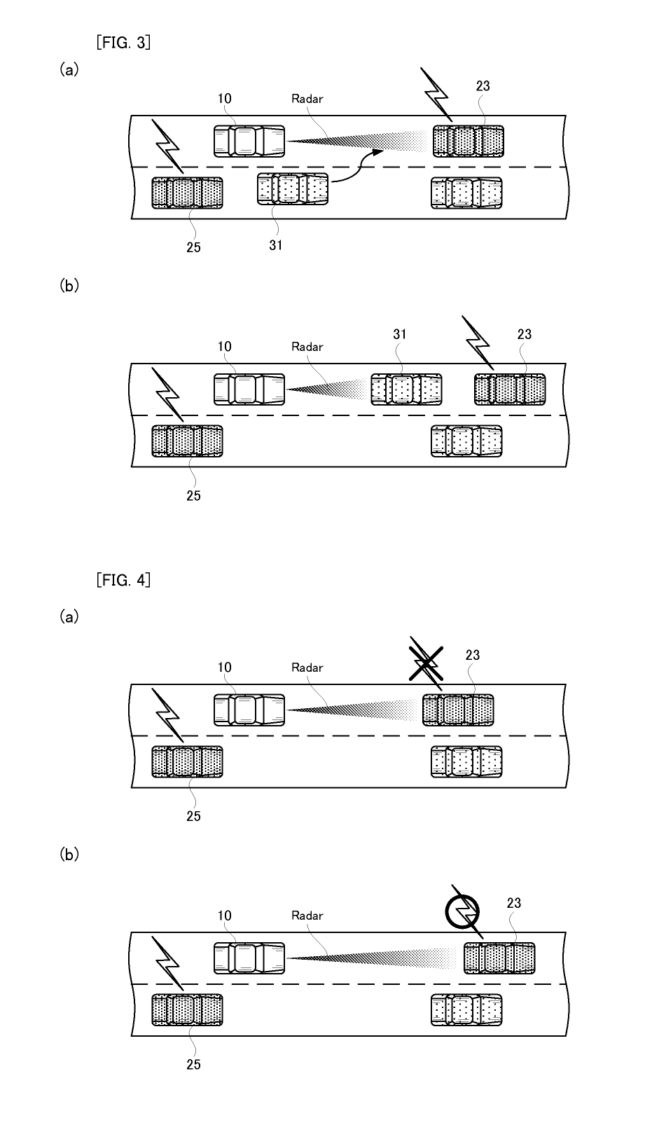

For example, if another vehicle (a non-communication vehicle 31 herein) cuts in between the self-vehicle 10 and the communication vehicle 23 when the communication vehicle 23 is specified as the preceding vehicle of the self-vehicle 10 as illustrated in FIG. 3(a), then, the distance sensor 12 of the self-vehicle 10 detects an inter-vehicle distance between the non-communication vehicle 31 and the self-vehicle 10 (i.e. a new vehicle is detected by the distance sensor 12) as illustrated in FIG. 3(b).

As a result, the ECU 14 of the vehicle specifying apparatus 100 compares the vehicle information obtained via the vehicle-to-vehicle communicator 11 with the inter-vehicle distance detected by the distance sensor 12, thereby specifying the preceding vehicle of the self-vehicle 10.

Here, the communication vehicle 23 as the preceding vehicle until now is not necessarily the new preceding vehicle of the self-vehicle 10 as illustrated in FIG. 3(b). The ECU 14 thus eliminates the communication vehicle 23, from the preceding vehicle candidate when the preceding vehicle is specified next time. By virtue of such a configuration, it is possible to reduce the number of the communication vehicles to compare, thereby reducing the processing load of the ECU 14. Incidentally, FIG. 3 are conceptual diagrams illustrating another example of the driving state of the self-vehicle in the embodiment.

After one communication vehicle which exists in the communicable range of the self-vehicle 10 is specified as the preceding vehicle of the self-vehicle 10, when the one communication vehicle specified as the preceding vehicle (corresponding to the “particular vehicle” of the present invention) is detected by the distance sensor 12, and if the communication from the one communication vehicle specified as the preceding vehicle is stopped, then, the ECU 14 further includes the one communication vehicle specified as the preceding vehicle, in the preceding vehicle candidate when the preceding vehicle of the self-vehicle 10 is specified next time.

For example, it is assumed that the communication from the communication vehicle 23 is stopped once when the communication vehicle 23 is specified as the preceding vehicle of the self-vehicle 10 and the detection of the communication vehicle 23 by the distance sensor 12 is maintained as illustrated in FIG. 4(a), and then, the communication between the self-vehicle 10 and the communication vehicle 23 is recovered as illustrated in FIG. 4(b). In this case, the ECU 14 of the vehicle specifying apparatus 100 exceptionally compares the vehicle information obtained via the vehicle-to-vehicle communicator 11 with the inter-vehicle distance detected by the distance sensor 12, thereby specifying the preceding vehicle of the self-vehicle 10.

Here, as illustrated in FIG. 4, the communication vehicle 23 remains as the preceding vehicle of the self-vehicle 10. It is thus possible to appropriately specify the preceding vehicle of the self-vehicle 10 by including the communication vehicle 23 in the preceding vehicle candidate when the preceding vehicle is specified next time. Incidentally, FIG. 4 are conceptual diagrams illustrating another example of the driving state of the self-vehicle in the embodiment.

The “vehicle-to-vehicle communicator 11”, the “distance sensor 12”, the “ECU 14”, the “obtained vehicle information”, and the “detected inter-vehicle distance” in the embodiment are one example of the “obtaining device”, the “detecting device”, the “determining device”, the “first behavior information”, and the “second behavior information”, respectively. In the embodiment, one portion of the functions of the ECU 14 for various electronic control of the self-vehicle 10 is used as one portion of the vehicle specifying apparatus 100.

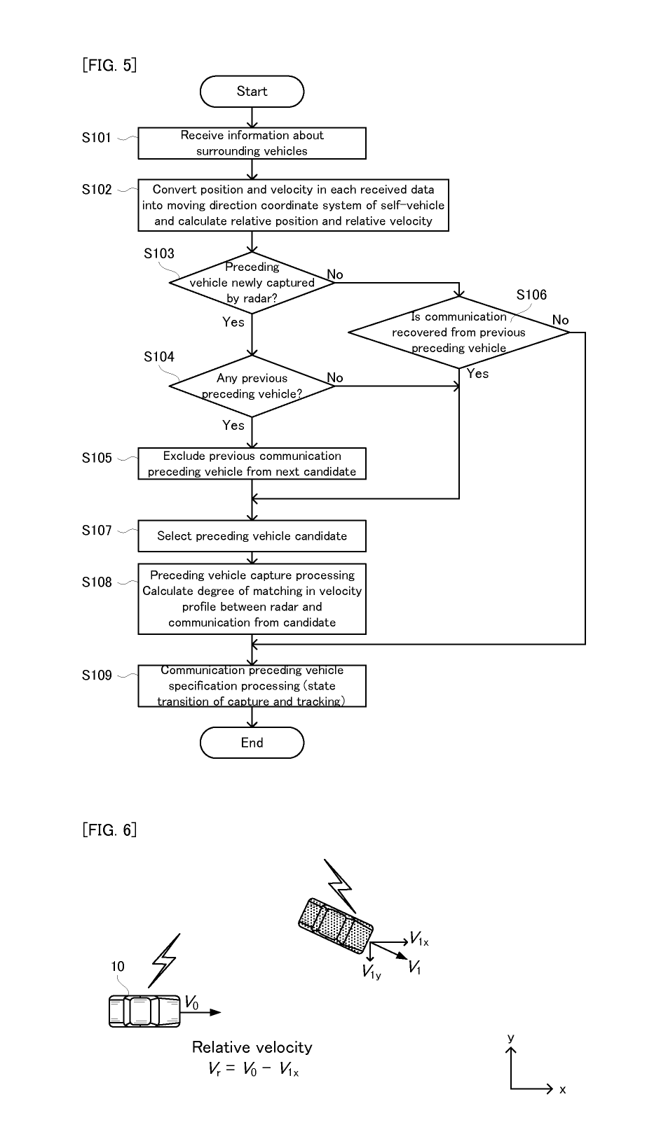

Next, vehicle specification processing performed by the ECU 14 as one portion of the vehicle specifying apparatus 100 as configured above will be explained with reference to a flowchart in FIG. 5.

In FIG. 5, firstly, the ECU 14 receives the vehicle information about the communication vehicles which drive around the self-vehicle 10 (i.e. in the communicable range of the self-vehicle 10) via the vehicle-to-vehicle communicator 11 (step S101).

The ECU 14 then converts the position and the velocity included in the received vehicle information into a moving direction coordinate system of the self-vehicle 10 on the basis of the received vehicle information, and the position and the velocity of the self-vehicle 10, and operates or calculates relative position and relative velocity (step S102).

Here, the expression “convert . . . into the moving direction coordinate system of the self-vehicle 10” means that a velocity V₁ of the communication vehicle is converted to an x-direction velocity V₁ₓ and a y-direction velocity V_{1y}, wherein the moving direction of the self-vehicle 10 is an x direction and a direction crossing the moving direction is a y direction, for example, as illustrated in FIG. 6. In this case, relative velocity Vᵣ between the self-vehicle 10 and the communication vehicle can be expressed as V₀-V₁ₓ, wherein V₀ is the velocity of the self-vehicle 10.

The ECU 14 then determines whether or not a new vehicle is detected by the distance sensor 12 (step S103). If it is determined that the new vehicle is detected (the step S103: Yes), the ECU 14 determines whether or not the preceding vehicle specified in the previous vehicle specification processing is the communication vehicle (i.e. whether or not the preceding vehicle until now is the communication vehicle) (step S104).

If it is determined that the preceding vehicle specified in the previous vehicle specification processing is the communication vehicle (the step S104: Yes), the ECU 14 excludes the communication vehicle specified as the preceding vehicle in the previous vehicle specification processing, from the preceding candidate in the next vehicle specification processing (step S105).

After the processing in the step S105, or if it is determined that the preceding vehicle specified in the previous vehicle specification processing is not the communication vehicle (the step S104: No), the ECU 14 selects the communication vehicle that can be the preceding vehicle (i.e. selects the preceding vehicle candidate) (step S107).

The ECU 14 then calculates the degree of matching between the velocity profile based on the received vehicle information and the velocity profile associated with the vehicle detected by the distance sensor 12 (i.e. the current preceding vehicle) (step S108)

The ECU 14 then specifies the preceding vehicle on the basis of the degree of matching calculated (step S109). Specifically, for example, under the condition that the degree of matching calculated is greater than a predetermined threshold value, the ECU 14 specifies the communication vehicle having the degree of matching that is greater than the threshold value, as the preceding vehicle. On the other hand, under the condition that the degree of matching calculated is all less than the predetermined threshold value, the ECU 14 determines that there is no communication vehicle that can be the preceding vehicle (i.e. the preceding vehicle is the non-communication vehicle).

In the processing in the step S103, if it is determined that the new vehicle is not detected (the step S103: No), the ECU 14 determines whether or not the preceding vehicle specified in the previous vehicle specification processing is the communication vehicle and the communication is recovered after the communication from the communication vehicle is once stopped (step S106).

If it is determined that the communication is recovered (the step S106: Yes), the ECU 14 performs the processing in the step S107. On the other hand, if the communication is not recovered, or if it is determined that the preceding vehicle specified in the previous vehicle specification processing is the non-communication vehicle (the step S106: No), the ECU 14 performs the processing in the step S109.

The present invention is not limited to the aforementioned embodiment, but various changes may be made, if desired, without departing from the essence or spirit of the invention which can be read from the claims and the entire specification. A vehicle specifying apparatus, which involves such changes, is also intended to be within the technical scope of the present invention.

### DESCRIPTION OF REFERENCE NUMERALS

10 self-vehicle
11 vehicle-to-vehicle communicator
12 distance sensor
13 vehicle speed sensor
14 ECU
15 throttle actuator
16 brake actuator
21, 22, 23, 24, 25 communication vehicle
31 non-communication vehicle
100 vehicle specifying apparatus

1. A vehicle specifying apparatus comprising: an obtaining device configured to obtain, by communication, first behavior information associated with one or a plurality of communication vehicles which drive around a self-vehicle and which can communicate with the self-vehicle; and a detecting device configured to detect second behavior information associated with another vehicle that drives around the self-vehicle, said vehicle specifying apparatus configured to compare the obtained first behavior information with the detected second behavior information, thereby specifying a preceding vehicle of the self-vehicle,
said vehicle specifying apparatus further comprising:
a determining device configured to determine whether or not a particular vehicle, which is a vehicle specified as the preceding vehicle, is set as a preceding vehicle candidate, according to whether or not detection of the particular vehicle by the detecting device is stopped when the particular vehicle is detected by the detecting device.

2. The vehicle specifying apparatus according to claim 1, wherein the determining device excludes the particular vehicle from the preceding vehicle candidate under the condition that the detection of the particular vehicle by the detecting device is stopped.

3. The vehicle specifying apparatus according to claim 1, wherein the determining device further sets the particular vehicle detected by the detecting device as the preceding vehicle candidate if communication from the particular vehicle is stopped when the particular vehicle is detected by the detecting device.
